(19) United States
(12) Patent Application Publication
(10) Pub. No.: US 2013/0018119 A1
(43) Pub. Date: Jan. 17, 2013

(54) FILTER MATERIAL FOR SEPARATION OF HYDROPHILIC SUBSTANCES FROM VARIOUS HYDROPHOBIC LIQUIDS OR GASES AND METHOD FOR PREPARATION OF THE MATERIAL

(71) Applicants: Vitali Chipizubov, Peterburi (RU); Priit Post, Harjumaa (EE); Rene Peterson, Tallinn (EE); Toomas Kaevand, Tallinn (EE)

(72) Inventors: Vitali Chipizubov, Peterburi (RU); Priit Post, Harjumaa (EE); Rene Peterson, Tallinn (EE); Toomas Kaevand, Tallinn (EE)

(73) Assignee: OU BIOCONSULT, Harjumaa (EE)

(21) Appl. No.: 13/517,432

(22) PCT Filed: Dec. 20, 2010
(86) PCT No.: PCT/EE2010/000018

§ 371 Date: Sep. 24, 2012

(30) Foreign Application Priority Data
Dec. 21, 2009 (EE) P200900094

(51) Int. Cl. C08F 216/06

(52) U.S. Cl. 521/141

(57) ABSTRACT

A filter material and method for its preparation for separation of hydrophilic substances from environment of various hydrophobic liquids or gases. Such hydrophobic substances can be different chemical and oil products, substances of biological origin (fats, essential oils). Hydrophilic substance can be water, lower alcohols (methanol, ethanol), polybasic alcohols, substances dissociating in aqueous solution (salts, acids or bases). Filter material is in the form of oxygen containing polymer, which microscopic and macroscopic structure forms during polymerization process. More precisely the filter material consists of polyacetal for example polyvinylacetal. Polymeric structure of filter material forms during synthesizing reaction of the polyacetal by the action of the assisting substances taken into reaction medium.

This invention belongs into the field of liquid and gas purification. More specifically, this invention covers a filter material intended for separation of hydrophilic substances from hydrophobic environment. The filter material used in the invention enables to separate hydrophilic substances, such as water, from various hydrophobic substances, such as alkane mixtures.

### TECHNICAL LEVEL

JP 4250807 (A) discloses a method for production of a filter, which has small uniform continuous apertures, which is suitable for filtering, and which consists of perforated polyvinyl acetal case. The mixture containing polyvinyl alcohol and starch grains is aged approximately 1 hour at the temperature that does not transform the starch grains into alpha type. After ageing a cross-linking agent and catalyst are added to the mixture to achieve a reaction, producing a cross-linked product. Also an anti-foam agent is added to the mixture.

JP 4139236 (A) discloses a production method of porous material, which is suitable for a filter, which has fine, uniform and open cell structure, by ageing of the mixture of polyvinyl alcohol, starch and cross-linking agent (formaldehyde or benzaldehyde) at certain temperature, until the mixture achieves a certain viscosity, adding catalyst (such as sulphuric acid or hydrochloric acid) and cross-linking the mixture.

CN 1296025 (A) discloses a production method of macromolecular microporous filter material, characterised by the fact that polyvinyl alcohol and linear aqueous solution of phenolic resin are added to starch solution of porous adjuvant, and the mixture of acidic aldehyde is used, to cause an acetalic reaction and curing reaction, the abovementioned materials are mixed and polyvinyl acetal and phenolic resin are transferred into a microporous material with filtering properties.

The filter material described in this invention is unique for its properties as well as method of production. The filter material described in this invention has simple character, is able to decompose various disperse systems (emulsions, aerosols), reusable and light.

The chemical compound polyvinyl formal has very broad physical characteristics. The invention disclosed below describes polyvinyl formal filter as an additional means for purification of fuels. A polyvinyl formal filter is described, which has been synthesized in such way that it operates without any additives. A material produced through synthesizing of polyvinyl formal is described, which enables to use this material for the production of various filters with maximum physical characteristics (fuel, air, gas, water, oil etc).

### SUMMARY OF THE INVENTION

Proceeding from the need to find an efficient industrially applicable method and suitable material for separation of hydrophilic substances from the environment of hydrophobic liquids or gases as a continuous process, a material with specific properties has been created.

The filter material is a polymeric oxygen-containing material by its nature, which final properties and microstructure come into being in the course of this synthesis process.

More specifically, the filter material is acetal of polyalcohol or polymer containing aliphatic OH (hydroxy) groups, which is produced in result of a reaction between polyalcohol and aldehyde. This reaction takes place by the presence of an acidic catalyst. Suitable catalysts are various aggressive acids, such as sulphuric acid.

The aspect of critical importance from the standpoint of achievement of the properties of the filter material is its microstructure, more specifically the dimensions and volume of pores. The formation and properties of pores will depend on the excipients added to the reaction mixture. Ideal excipients are polymers that gelate easily and hydrolyse in an acidic environment. Such polymers are polysaccharides or polyesters. A small quantity of water is added into the reaction environment together with the excipient or excipients, in order to ensure gelation. No water is necessary, if aqueous solution of an aldehyde is used.

The idea of excipient or excipients is that if they are added into the reaction environment together with a small quantity of water and the main components (polyalcohol and aldehyde), they form a uniform gel structure there. A gel formed of the excipient or excipients in the reaction environment will start to decompose under the influence of an acidic catalyst simultaneously with the formation of acetal between polyalcohol and aldehyde. The reaction of formation of acetal takes place under normal pressure in temperature range 50-150° C.

After the passing of time needed for reactions (usually 3-5 hours), polyalcohol has become a polyacetal and the excipients have been hydrolysed. A network of pores remains at the place of gel structure decomposed in result of the hydrolysing of the excipient or excipients. The formed filter material is washed with water or some other solvent, in order to remove various residual substances (non-reacted aldehyde, hydrolyse products of the excipient, catalyst).

A suitable polyalcohol for the production of filter material can be any polymer, which contains one aliphatically bound OH group per at least twelve carbon atoms of a polymer or (number of C-atoms)/(number of aliphatic OH groups)≦12. A preferred ratio is 1 (one) OH group per 4 (four) carbon atoms and ideal ratio is 1 (one) OH group per 2 (two) carbon atoms. Also mixtures of several different polyalcohols can be used.

Suitable aldehydes for the production of filter material contain one to six carbon atoms, including methanal, ethanal, propanal, butanal, pentanal, hexanal and relevant isomers, if these are possible. The preferred aldehyde is methanal (formaldehyde). Furthermore, mixtures of several abovementioned aldehydes can be used.

Suitable excipients are various polysaccharides or polyesters or their various mixtures. Starches are preferred, especially potato starch.

Operation principle of the porous filter material consisting of polyalcohol formal lays in its ability to collect electrically charged molecules or molecules of strongly polarised substances on the walls of pores under the influence of electrostatic forces. The molecules gathering on the walls of pores start to form continuously growing sets, until they reach a sufficient size to precipitate out of the filter. Such collection on the walls of pores and later precipitation enables to separate hydrophilic substances occurring in hydrophobic environment in the form of an emulsion or aerosol into clearly distinguishable fractions.

Such hydrophobic environments, where hydrophilic substances occur in the form of emulsions or aerosols, can be for example oil products (petrol, diesel fuels, oils), chemical products (such as Fisher-Tropsch products), substances of biological origin (vegetable and animal fats, essential oils), natural gas. Hydrophilic substances separated with the help of the filter material are usually water, lower alcohols (C1-C3), polybasic alcohols, organic and inorganic substances dissociating in aqueous solution (salts, acids or bases).

### REALISATION EXAMPLE OF THE INVENTION

For the production of filter material, polyalcohol, aldehyde, excipient and catalyst will be mixed.

Components of the mixture used for the production of filter material:

1. Polyvinyl alcohol (manufacturer: Japan VAM & POVALCo., Ltd., mark VC-13)—1 kg

2. Aqueous formaldehyde solution (36%)—1 kg

3. Potato starch—1 kg

4. Sulphuric acid (97%)—1 kg

The components needed for the production of filter material will be mixed in a special container at the temperature 30-40° C. First polyvinyl alcohol and aqueous formaldehyde solution will be mixed together, followed by potato starch, and finally sulphuric acid will be added carefully. The resulting mixture will be mixed at relevant uniform temperature and cooled, if necessary, until a homogeneous mass has been prepared.

The resulting mixture will be poured into a mould or moulds and kept 4 hours in a thermostat at the temperature. 80° C. During the period of stay in the thermostat formaldehyde and polyvinyl alcohol will react mutually with each other, resulting in the production of polyvinyl formal. Simultaneously with the formation of polyvinyl formal the hydrolysis of potato starch takes place, resulting in glucose well soluble in water.

After 4 hours the raw filter material will be taken out of the moulds and washed with water, until all acid having acted as the catalyst, excess formaldehyde and hydrolysis products of potato starch have been separated from filter material. Washing can be considered finished, if pH of the washing water is neutral.

After washing with water the filter material will be dried 7 days at room temperature.

After drying the result will be a light, white and porous substance, which can be used as filter material.

Table 1 shows the results of analyses performed with the used cooking oil before (Test result of oil A) and after (Test result of oil B) processing with a filter made of the filter material produced with the abovementioned method.

TABLE 1

| | Measuring | Test | Test result of | Test result of |
|---|---|---|---|---|
| Quality parameter | unit | method | oil A | oil B |
| Solids content | mg/kg | ISO 2662 | 4328 | 2 |
| Water content | Mass percent | ISO 3733 | 1.94 | traces* |

Notes:
oil A—before filtration
oil B—after filtration
*lower than test method ISO 3733
The results of analysis are valid for the sample brought for analysis.

1. Filter material for separation of hydrophilic substances from the environment of various hydrophobic liquids or gases, where the hydrophobic substances are chemical compounds not soluble in water at the temperature 60° C. in liquid or gaseous state, including oil products such as petrol, diesel fuels, oils, chemical products, substances of biological origin, including vegetable and animal fats, essential oils, natural gas, and where the hydrophilic substances are water, lower alcohols such as CI-C3, polybasic alcohols, organic and inorganic substances dissociating in aqueous solution, including salts, acids and bases, characterized in that chemically the filter material is acetal of a polyalcohol, obtained in result of a reaction between polyalcohol and aldehyde by the presence of an acidic catalyst, using excipients.

2. Filter material of claim 1, characterized in that the acidic catalyst is sulphuric acid.

3. Filter material of claim 1, characterized in that acetal of a polyalcohol is acetal of a polymer containing aliphatic hydroxy groups.

4. Filter material of claim 2, characterized in that polyalcohols are polymers, which polymer chain includes at least 1 (one) aliphatically bound OH group per 12 carbon atoms, including polyvinyl alcohol.

5. Filter material of claim 2, characterized in that aldehydes are CI-C6 aldehydes, including formaldehyde methanal.

6. Filter material of claim 1, characterized in that the filter material has porous structure obtained in the course of synthesis of acetal of a polyalcohol by the presence of one or several excipients.

7. Filter material of claim 1, characterized in that excipients are easily hydrolyzing polymers, including polysaccharides, polyesters.

8. Method for the production of filter material, comprising following stages:
easily hydrolysing polymer and water will be added to the reaction mixture containing polyalcohol and aldehyde, in order to form pores,
simultaneously with the formation reaction of acetal the hydrolysing reaction of excipient takes place, in which result the molecules of excipient will be decomposed into smaller ingredients,
acetal of polyalcohol with porous structure is obtained,
of which decomposition products of the polymer used as excipient will be separated.

9. Method of claim 8, characterized in that suitable excipients are used in the reaction in order to achieve required size of the pores of filter material.
